(19) United States
(12) Patent Application Publication
(10) Pub. No.: US 2017/0097143 A1
(43) Pub. Date: Apr. 6, 2017

(54) DECORATIVE LIGHT BAR ACCESSORY

(71) Applicants: John Curtis Kominski, Glendale, AZ (US); Lisa Marie Wade, Avondale, AZ (US); Richard Travis Teitzel, Avondale, AZ (US)

(72) Inventors: John Curtis Kominski, Glendale, AZ (US); Lisa Marie Wade, Avondale, AZ (US); Richard Travis Teitzel, Avondale, AZ (US)

(21) Appl. No.: 15/286,484

(22) Filed: Oct. 5, 2016

Related U.S. Application Data
(60) Provisional application No. 62/237,450, filed on Oct. 5, 2015.

(51) Int. Cl. F21V 17/04; F21V 17/10; F21S 8/00

(52) U.S. Cl. CPC F21V 17/04; F21S 8/033; F21V 17/10; F21W 2121/00

(57) ABSTRACT

A decorative light bar accessory having a three-sided frame of two frame sides and a frame middle segment, each of the frame sides and the frame middle segment having a frame top and a frame back, the frame sides being attached to the frame middle segment at approximately right angles and having a free frame end, each frame top having a plurality of spaced apart holes, the holes sized to accommodate hooks for decorations that are suspended therefrom, and the free frame ends being adapted to suspend the decorative light bar accessory over a light bar. A light bar accessory kit includes packaging with instructions; the light bar accessory; and decorative elements to be disposed on the accessory. This unique system allows consumer to affordably upgrade an existing light systems to newer and more appealing appearances, increasing the desirability of the home and realty.

### TECHNICAL FIELD

This application relates generally to light fixtures and more specifically to an accessory providing decorative elements to an existing light bar.

### BACKGROUND

The light bar is a common residential and commercial light fixture. It is easily installed and provides multiple lights, usually of relatively low voltage. The light bar has one electrical connection, which is fed to multiple lights, usually between three and five. The lights are exposed and can be easily replaced. The light bar is inexpensively manufactured and quickly installed by an electrician. However, the ubiquitous light bar has come to be viewed as cheap and boring.

When occupants do become bored with their light bars, they have no economical, convenient alternatives. Upgraded light bars with reflective crystals have recently come on the market, but are very expensive and require replacement and installation by someone familiar with electrical wiring.

### SUMMARY OF INVENTION

In one embodiment, a decorative light bar accessory includes a three-sided frame having two frame sides and a frame middle segment, each of the frame sides and the frame middle segment comprising a frame top and a frame back, the frame sides being attached to the frame middle segment at approximately right angles and having a free frame end, each frame top having a plurality of spaced apart holes, the holes sized to accommodate hooks for decorations that are suspended therefrom, the free frame ends being adapted to suspend the decorative light bar accessory over a light bar.

Optionally the decorative light bar accessory also has an end piece whose two ends are attached to the two free frame ends. In another embodiment, the decorative light bar accessory has an end piece has two interfaces that fit into a mounting bracket, thereby suspending the decorative light bar accessory over a light bar. In yet another embodiment, the decorative light bar accessory has two interfaces on the end piece that are vertical legs that can be inserted into a mounting bracket. In yet another embodiment, the decorative light bar accessory has an end piece whose two ends are attached to the free frame ends, the end piece further including a plurality of legs that can be inserted into a mounting bracket having two bars attached to each other longitudinally and in parallel and cantilevered to provide an overlap of about 50%, the two bars being attached in a spaced apart fashion, leaving room for insertion of the legs, with one bar designed to interface in the vicinity of the light bar with screw holes to insert screws for attachment to a wall.

In yet another embodiment, there is provided an aesthetic accessory to an existing light bar that includes a) a mounting clamp comprising a short narrow section of metal with folded ends, with the section being sized to encircle the compression ring of a light bulb of an existing light bar, each folded end having at least one hole through which a bolt is passed and onto which a fastening nut is screwed; b) at least two frame supports, each of which has two ends, one end attached to the mounting clamp and a second end attached to a frame bar; c) at least one frame bar that is attached to at least two frame supports, the frame bar extending at least the width of a light bar and having two ends that are bent to cover the light bar, the frame bar having holes at intervals; and d) a plurality of decorations that are suspended from the holes in the frame bar.

Optionally, the frames are fabricated to various lengths, which attach to standard consumer light bar fixtures. The frame is affixed to either the existing fixture or to the wall. The frame is affixed to the wall via a typical consumer mounting system. The frame is affixed to the light fixture via a clamping system. The aesthetic light valance is added to the frame through either an after-assembly attachment by the consumer or by permanent attachment at the time of manufacture. The fixture is a wall mounting system that comprises a short narrow section of metal with folded ends, with the section being sized to encircle the base of an existing light bar. The accessory is a decorative bar, which contains holes and/or other means of attaching decorative objects, thereby providing a new aesthetic appearance, thereby better reflecting and distributing light from the light bar fixture.

In another embodiment, there is provided a light bar accessory kit including a) packaging including instructions for assembly and use as directed; b) the light bar accessory; and c) decorative elements to be disposed on the accessory. Optionally, the decorative elements are a) Decorative Crystals and Glass Materials; b) Seasonal decorations (e.g. Halloween); c) Sports themes (e.g. teams and team); and/or d) Miscellaneous Themes (e.g. personalization).

In yet another embodiment, there is provided a method for adding an aesthetic accessory to an existing light bar. This method has the steps of a) providing a light bar accessory, comprising i) a mounting clamp comprising a short narrow section of metal with folded ends, with the section being sized to encircle the compression ring of a light bulb of an existing light bar, each folded end having at least one hole through which a bolt is passed and onto which a fastening nut is screwed; ii) at least two frame supports, each of which has two ends, one end attached to the mounting clamp and a second end attached to a frame bar; iii) at least one frame bar that is attached to at least two frame supports, the frame bar extending at least the width of a light bar and having two ends that are bent to cover the light bar, the frame bar having holes at intervals; iv) a plurality of decorations that are suspended from the holes in the frame bar; and v) a light bar frame fastening system to attach the frame to either the light fixture or the wall behind the fixture; b) turning light switch to off position; c) removing two outer light bulbs and compression ring fittings from the light fixture; d) slipping the light bar accessory over two bare light bulb holders; and e) replacing compression rings and light bulbs.

### BRIEF DESCRIPTION OF DRAWINGS

FIGS. 1A and 1B show a 4-bulb light bar with a double accessory bar. FIG. 1A is a perspective view of the accessory bar on the light bar and FIG. 1B illustrates the top view of the product. FIGS. 1A and 1B directly refer to the frame mounting system.

FIG. 2A shows a disassembled light bar with two light bulbs and their compression ring fittings removed and shown in FIG. 2B. FIG. 2B is an exploded transverse view of the removed parts of the light bar and the light bar accessory. Transverse lines indicate how to line up accessory mounting plates, lights and compression ring fittings.

FIG. 3A demonstrates the overall clamping system. FIG. 3B is an enhanced view illustrating the clamp mounting locations for the frame support.

FIGS. 4A-4D demonstrates the frame system without a valance, based on a 4-bulb light bar frame. FIG. 4A is a transverse view of a one-bar accessory with mounting plates. FIG. 4B shows a standard 4-bulb light vanity bar that will use such a system. FIG. 4C is the bare frame aerial view, with FIG. 4D being a transverse view, showing the frame with the valance and decoration, along with a light indicating the position of the light fixture.

FIG. 5 shows an L-shaped sheet of metal that becomes the frame of the new accessory.

FIG. 6 shows the L-shaped metal with notches at the corners of the frame.

FIG. 7 shows the L-shaped metal bent, aided by a heating torch, in a three-sided frame.

FIG. 8 shows holes drilled at intervals to accept the hooks of decorations.

FIGS. 9A-9D show an embodiment of a notch pattern. FIG. 9A shows smaller notches among the holes; FIG. 9B shows exemplary dimensions; FIG. 9C illustrates the holes and notches with decorations; and FIG. 9D is a larger version of a portion of FIG. 9C showing the relationship of the hooks to the holes.

FIG. 10A shows the three-sided frame and ends. FIG. 10B shows an end piece that completes the frame rectangle and has legs for mounting.

FIG. 11 illustrates the assembly of two bars and positioning to form a cantilevered shape to accept the legs and abut the wall.

FIG. 12 shows the two bars tack welded together to form the mounting bracket.

FIG. 13 shows predrilled holes for convenient wall attachment.

FIG. 14 shows the mounting bracket into which screw are being inserted.

FIG. 15 shows the new frame positioned above the mounting bracket and arrows indicating inserting of the legs into the mounting bracket.

FIG. 16 is an overview of the decorated light bar.

### DETAILED DESCRIPTION

We have invented a light bar accessory system that accompanies and enhances many standard consumer light bars in the marketplace. This unique light bar accessory system comprises two methods for fastening to an existing light bar, wherein the light bar is converted into a new aesthetically pleasing fixture, enhancing the value of the immediate room and the realty as a whole.

The first method for fixture is a mounting clamp comprising a short narrow section of metal with folded ends, with the section being measured to encircle the base of an existing light bulb. For the clamp, a metal strip is cut and the ends folded over. The ends have holes through which a bolt is passed and onto which a fastening nut secures the bolt.

The second method for fixture is a mounting plate, which is inserted under the light bulb and the compression ring fitting around the base of the light bulb. Both attachment methods require no electrician and are easy for consumers.

The Inventors have been involved in realty as well as new dwelling construction, remodeling and designing for many years. In the myriad of observed homes, at least 90% have a plain light bar in the bathroom. The most common complaint and first thing almost every home purchaser wanted to change was this ugly and cheap bathroom light bar. On behalf of clients, the Inventors have shopped for replacement light fixtures, which typically cost many times the price of the light bar, often $300-$500 per light. From these circumstances, we discovered a need for a frame to hold “bling” and attach to the existing light bar fixture. Further design and discovery produced an accessory to attach to the existing light bar, thereby creating an expensive-looking and elegant light fixture for a fraction of the cost of a new fixture—and without the need to hire an electrician to install it. First, we designed the frame for easy attachment to an existing light bar and then an overlying valance, to which are attached embellishments or decorations. Initially, we suspended crystals from the valence; thereafter, a line of other hanging decorations, including but not limited to seasonal decorations, sports objects, etc, were attached in a similar fashion, giving a different product and a different look and providing still more choices for a consumer.

Not only is the light bar accessory a decorative upgrade, but the crystals also spread the light therefrom in a more attractive and interesting pattern. For realtors, the light bar accessory is an instant upgrade in an otherwise tired, but too-expensive-to-fix bathroom. Thus, in minutes, we help realtors and home sellers make any home more sellable. For home owners or even apartment dwellers, decorating can be upgraded efficiently and inexpensively; they can simply purchase and attach the light bar accessory quickly by themselves, without using tools or having to hire and wait for an electrician to remove and replace a more expensive light fixture.

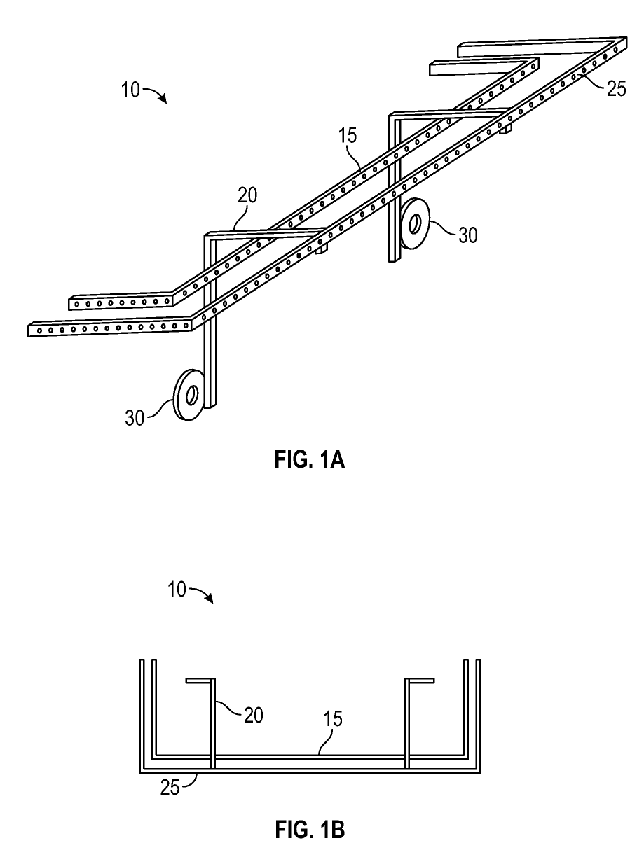

Turning now to FIGS. 1A and 1B, we see overviews of an embodiment of the light bar accessory. FIG. 1A is a transverse overview of the accessory 10. The accessory 10 shown herein is our frame with two bars. This accessory 10 has two parallel bars: the basic frame bar 15 and the metal enclosure 25. Supporting both bars are the frame supports 20. One end of the frame support 20 attaches to the frame bar 15, and when it is present the metal enclosure 25. The other end of the frame support 20 attaches to a clamp (not shown), mounting plate 30, or other attachment to the light bar. FIG. 1B is a top view of the accessory 10, showing the frame bar 15, metal enclosure 25 and frame support 20.

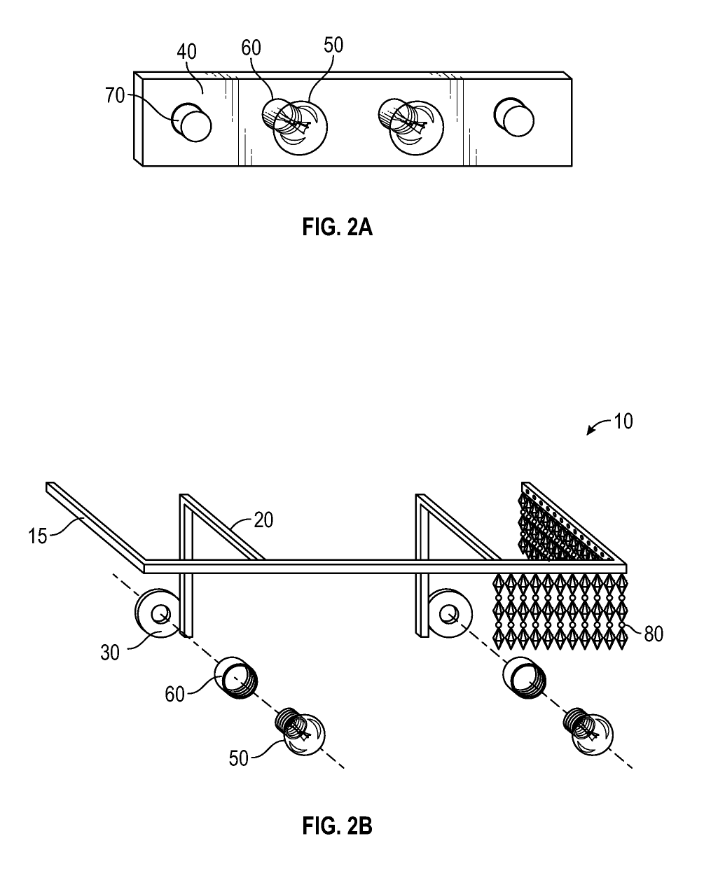

FIG. 2 is an exploded view of one embodiment of the accessory 10 being attached to the light bar 40. This embodiment of the accessory 10 has a frame bar 15, attached to a frame support 20 and to the mounting plate 30. As shown herein, the light bar 40 has two light bulbs 50 removed, as well as the compression ring fittings 60. For installation the mounting plates 30 are fitted over the light bulb base 70. Once the mounting plates 30 are in place, the compression ring fittings 60 are placed over the light bulb bases 70. Finally, the light bulbs 50 are screwed in. The decorations 80 can be attached to the accessory 10 before or after installation of the accessory 10 on the light bar 40.

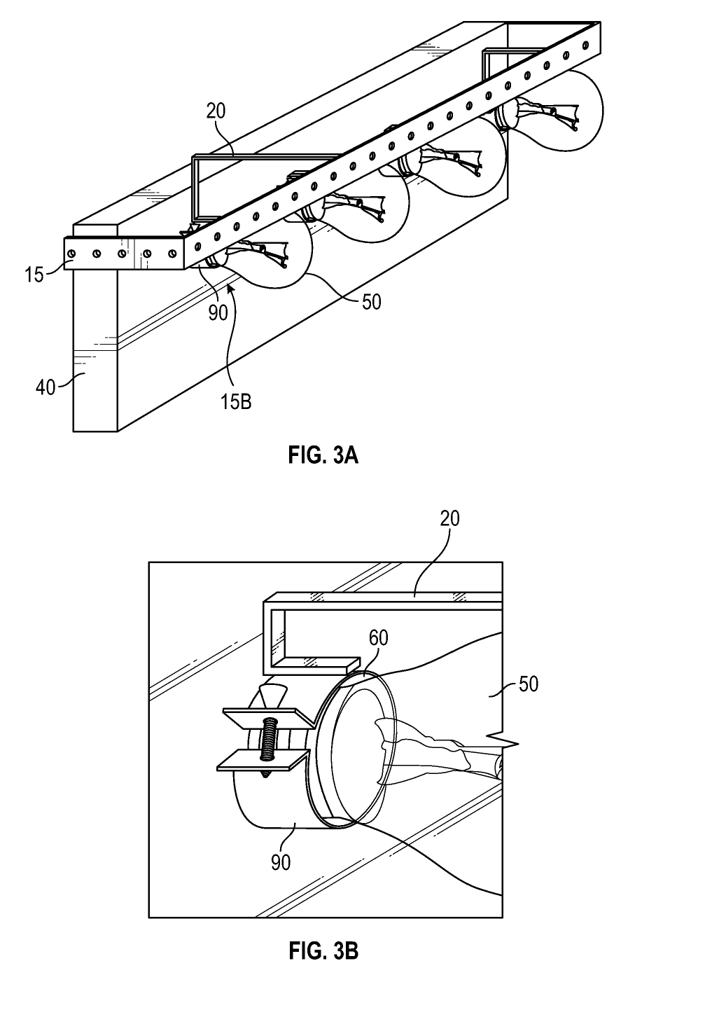

FIGS. 3A and 3B also show the one-bar accessory 10, but this embodiment is installed with the use of mounting clamps 90, not the mounting plate (not shown). In this embodiment, the frame support 20 attaches to the clamp 90 with an extra bend; however, other attachment configurations are contemplated. The clamp 90 surrounds the compression ring. In this configuration, the purchaser only needs to remove the light bulbs 50 to install the accessory 10. In a preferred configuration, the frame bar 15 has a side that extends to approximately cover the light bar 40. In this configuration, the hanging decorations 80 “hide” the underlying light bar 40.

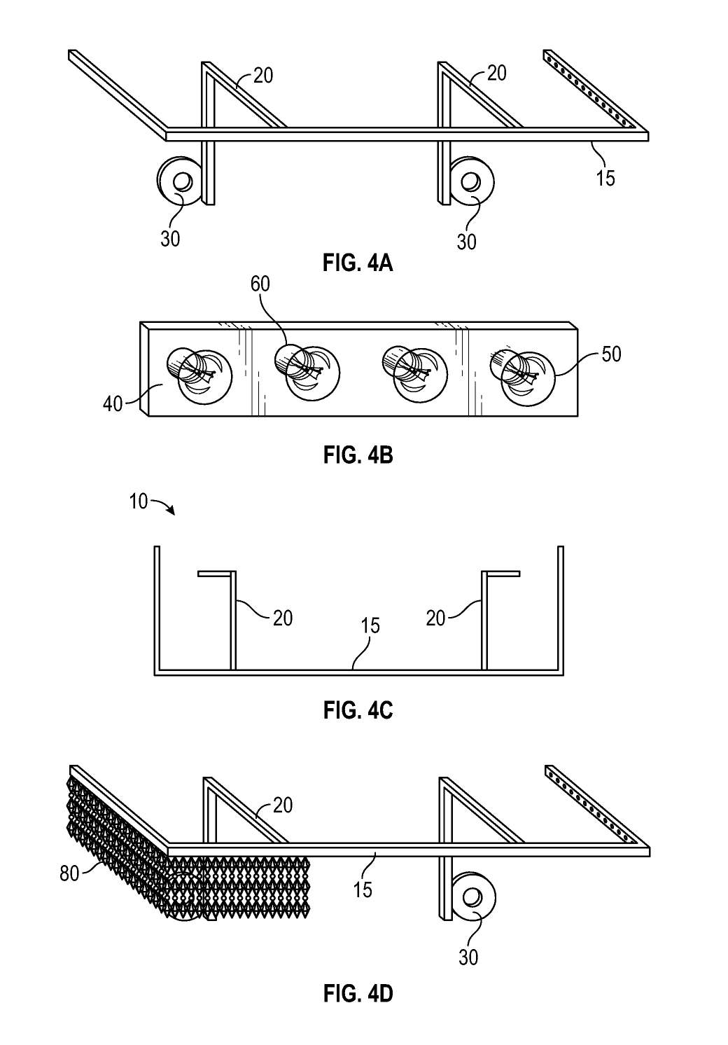

FIGS. 4A to 4D also feature the one-bar accessory 10 (without the extra “valance” of FIG. 1). FIG. 4A shows more detail of the accessory 10 of FIG. 2. This accessory 10 has a single mounting bar 15 and two mounting supports 20, to which are attached mounting plates 30. FIG. 4B shows a typical light bar 40 with four light bulbs 50, each having a collar or compression ring fitting 60. FIG. 4C is a top view of a “bare” (without decorations) accessory 10, with mounting bar 15 and two mounting supports 20. FIG. 4D is a cutaway representation of the one-bar accessory 10 with the decorations 90 partially installed.

Following are examples with more complete descriptions of how to make and use the accessory 10.

### Example 1

We started with an embodiment of the assembly of the simplest light bar accessory, one to accommodate a 3-bulb light bar. This has a clamp-style mounting clamp that fits over the light bulb's compression cover (FIGS. 3A and 3B). The mounting clamps are described, and then the base frame as well as decorative bar.

The mounting clamps 90 are fabricated from 2 to 2½″ round by 1½ deep pieces of metal with approximately ⅛″ thickness and not to exceed 2¼″ diameter. The diameter and thickness can vary, as long as the metal is strong enough to weld and to support the accessory 10 and decorations 80. We cut completely down the center of the depth of round metal. We bent approximately ¼″ at 90 degrees outward on each side of cut to allow a hole to be drilled big enough to fit a ⅛″ wing nut-type screw. This formed the clamp shown in FIG. 3B. We drilled a 5/32d″ hole in the center of both tabs that were just bent.

For the frame supports, we cut two pieces of flat metal approximately ¼″ wide by ⅛″ thick by 10¼″ in length. The metal used can be flat or round. The metal can vary in width and thickness as long as the metal is weldable, lightweight and strong enough to support the rest of the frame and the decorative embellishments. With the two pieces lying flat, we measured 1½″ from one end and proceeded to bend each metal piece to a 90-degree angle. We measured 1¾″ from the second bend and again bent the metal to 90 degrees. Then we measured 6½″ from the third bend and bent the metal at 90 degrees inward again. This left ½″ length at the end and created two identical base frames in an incomplete rectangle shape (FIG. 1).

We placed both mounting clamps with the 90-degree bends facing each other 12″ apart measuring from the center of the inner diameter. Next we placed the mounting supports 20 with the first bends facing upward against the top of each mounting clamp 90 so that the mounting support's 1½″ segment ran the depth of the 1½″ mounting clamp 90 (FIG. 3B). Then we welded the frame supports 20 to the mounting clamps 90 for added security.

Next we created the frame bar 15. We cut flat metal bar about ¼″ wide by ⅛″ thick and 32½″ long, although the width and thickness can vary. We drilled 3/32″ holes at intervals of about ½ down the center of the flat part of the 32½″ frame bar 15, recognizing the intervals can vary with the size of decorations 80 to be used, etc. In one embodiment, the material of the frame bar 15 is also chosen for its decorative appearance, which removes the need for a finished valance (metal enclosure 25). Then we measured 7¼″ from each end of the frame bar 15 and there bent both ends of the flat side of metal 90 degrees inward to form an end piece.

We centered the frame bar 15 flat on the outside of the ½″ pieces of metal from both base frames' last bend. The frame bar 15's bent ends preferably face down. The frame bar 15 is then securely welded to the frame support 20. For esthetics, we next ground the welds flat and primed and painted the accessory 10 or finished it in chrome. The medallions, crystals or other desired decorations 80 are then attached.

To build a double-valance accessory, we completed the product disclosed above, supplementing the frame bar with an additional surrounding metal enclosure 25, which ensures that the valance can safely and securely attach to the overall accessory 10.

### Example 2

FIG. 2 shows straightforward installation of the accessory 10 and is geared to the untrained consumer. First, the purchaser turns off the light switch (not shown) for the light bar 40 in the bathroom. Second, the purchaser removes the light bulb(s) 50 and compression ring fitting(s) 60 from the light bar 40. Next the user fits the mounting plates 30 onto the lamp bases 70. Then the purchaser replaces the compression ring 60 and light bulb 50. The final step is turning on the light bar to enjoy the new look, obtained quickly and inexpensively. The decorative crystals or other hanging decorations 80 can be suspended from the accessory 10 before or after installation.

### Example 3

Our design for a light bar accessory 10 to fit over a 4-bulb light bar 40 is disclosed herein. The mounting clamps 90 may be prepared as in Example 1 (and illustrated in FIG. 3B). The frame supports 20 and frame bar 15 are similarly built. The metal enclosure 25 is longer (about 38½ inches for a typical 4-bulb light bar). Turning to the frame bar 15, or second valance, it too is longer (about 34½ inches typically). The ends of the metal enclosure 25 are also turned inward 90 degrees about 6½ inches from the ends. For this larger accessory 10 and to connect the frame bar 15 and the metal enclosure 25, we optionally provide four 1″ spacers (not shown), two of which are welded about 3″ from either end and two more spaced in the middle. Obviously more spacers or longer spacers can be used for structural integrity and esthetic purposes. Installation is similar to Example 2.

### Example 4

Our design for a light bar accessory 10 to fit over a 6-bulb light bar 40 is disclosed herein. The mounting clamps 90 may be prepared as in Example 1, or the mounting plates 30 can be used. The frame bar 15 and frame supports 20 are similarly built. The metal enclosure 25 is longer (38½ inches for a typical 6-bulb light bar). Turning to the frame bar 15, it too is longer (about 34½ inches typically). The ends of the metal enclosure 25 are also turned inward 90 degrees about 6½ inches from the ends. For this larger accessory, we prefer to provide four 1″ spacers (not shown), two of which are welded about 3″ from both ends and two more spaced in the middle. Obviously more spacers or longer spacers can be used for structural integrity and esthetic purposes. Installation is similar to Example 2.

### Example 5

For the longer 8-bulb light bar, we created a different arrangement that shows the breadth of the invention.

Rather than clamp 80 attachment (FIGS. 3A and 3B), we created mounting plates 30 (FIG. 1A). Preferably the mounting plates 30 have about a 3″ outside diameter by about ⅛″ thickness. Diameter and thickness can vary as long as the resulting metal is strong enough to weld and support the frame (see below). Preferably outside dimensions of the mounting plates 30 are at least 2¼″ and cannot exceed about 4¼″ in any direction (whether circular, square or other shape). The mounting plates 30 must have a sufficient diameter to stabilize the longer, heavier accessory with more decorations 80. A circular hole in the center of the mounting plate is intended to be between about 1¼ and 1⅞″ in diameter, suitable for fitting over the light bulb base 70. Each mounting plate 30 preferably has one outside straight edge of a minimum of about ¾″ to support welding. If mounting plates initially are circular, an outside portion of the mounting plate is removed to create a straight edge long enough to weld to the frame support 20. The straight edge should be at least about ¾″ to leave sufficient material between the straight edge and the edge of the circular hole to avoid compromising the strength and integrity of the mounting plate 30.

In this new design, to support the longer accessory with more supports, we started with three pieces of flat metal approximately ¾″ wide by ⅛″ thick by 12″ in length. The metal can be flat or round and vary in width and thickness as long as the metal is weldable, lightweight and strong enough to support the rest of the frame and decorative embellishments. With all the pieces lying flat, we measured 5″ from one end and bent all three pieces. Then we measured 5″ from one end of each piece and bent all three pieces again 90 degrees inward. This leaves a short end. Thus we created “U” shapes for all three metal pieces.

First we positioned the mounting plates. Starting from the left, we placed the first mounting plate 30 with the flat edge to the left. The second and third mounting plates 30 were placed with the flat edge to the right. Then we measured from the center of the diameter of each mounting plate 30 and placed the next mounting plate 30 about 12″ from the first mounting plate 30. Thus, the third mounting plate 30 is about 30″ from the first mounting plate 30. Therefore, the third mounting plate 30 is about 18″ from the center mounting plate 30. After these were placed, the distance from the center of the inside hole of the mounting plates 30 was determined. Next, we lined up the three frame supports 20 with the first bends facing upwards against the flat edges of the mounting plates 30 so that the center of the inside holes of the mounting places 30 were exactly 1¾″ from the inside of the first 90 degree bends. Once the frame supports 20 were position, they were securely welded to the mounting plates 30.

To form the metal enclosure 25 for this larger model accessory 10, we cut flat metal bars approximately ¼″ wide by ⅛″ thick and 65½″ long (against width and thickness can be varied). We drilled 3/32″ holes every ½″ down the center of the flat part of the 65½″ long metal piece. Again, spacing can be varied, depending on the size of the hanging accessories and other factors. We measured 6¼″ from each of the metal enclosure 25, and bent the flat side of the metal 90 degrees inward toward each other to form a “u”. The center metal enclosure 25 is preferably placed flat on the outside of the ½″ pieces of metal from the frame supports. Note: the 90 degree bends of the decorative bars should be facing down for attachment of the frame supports.

To build a double-valance accessory 10, we built to the original specification initially and then performed these additional steps. We cut the frame bar 15 to a length of 61½″. We drilled 3/32″ holes about every half inch, preferably offsetting them from the original valance. We bent each end inward 90 degrees at both sides, 6¼″ from the end, creating a “u” shape. This second valance is placed on the inside of the metal enclosure 25, mirroring the original valance, and placed one inch apart and welded in place. For extra reinforcement, four 1″ spacers are used. Two are welded about 3″ from either end and then one was welded between the first and second base frame and another between the second and third base frame. This step provides more structural integrity and keeps an inch of spacing between the two valances.

Installation is performed similarly to above, starting with turning off the light switch for the light bar. Then we removed the three bulbs and compression ring fittings from the light bar to line up with our three mounting plate holes. We slipped into place the accessory, replaced the compression rings 60 and light bulbs 50 and turned on the light bar 40 to enjoy the effect.

### Example 6

This new embodiment was developed to solve additional problems, such as the unsteadiness of some of the existing light bars, which being very light weight, were not installed to support the additional weight of our accessory, particularly after placement of the decorations. Moreover, for manufacturing in quantity, we decided to redesign the support of the accessory for wall installation above the existing light bars of different sizes. We also took into account the fact that the light bar may not be centered on joists in the wall, but our accessory is preferably screwed into a joist at least at one point or mounted with anchors. This embodiment was simpler to make and may be less expensive and easier for the consumer. Another advantage is there is no need to remove the light bulbs, their bases or fitting rings.

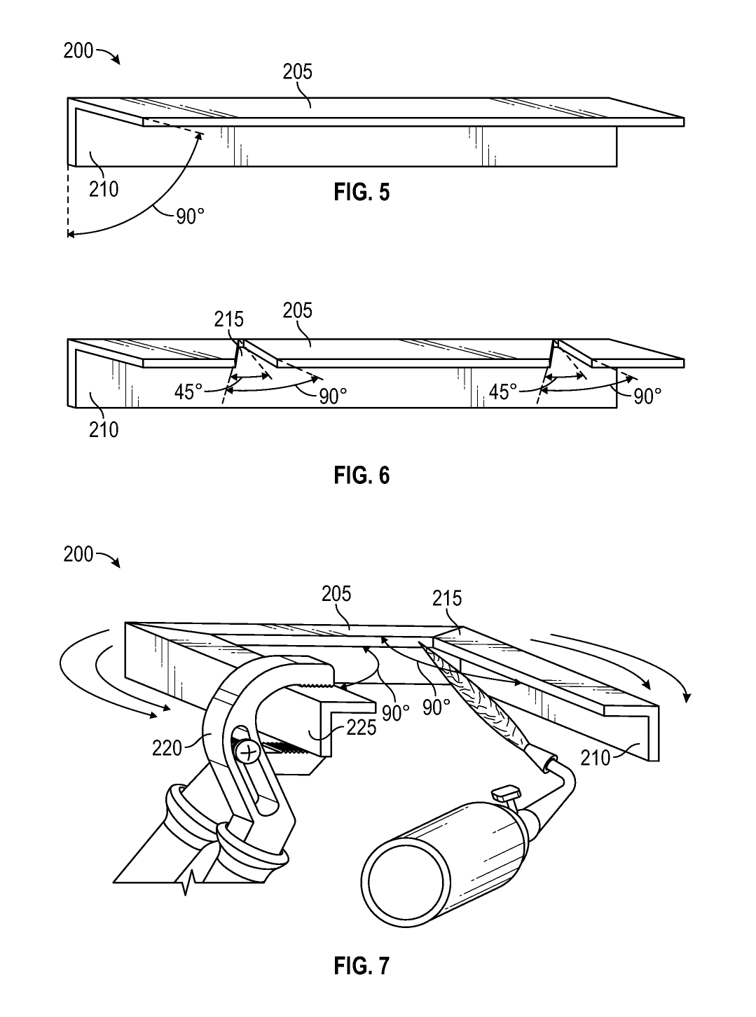

The start of the newer accessory frame 200 is shown in FIG. 5. It is based on an L-shaped light weight metal (preferably aluminum) sheet having a thickness of ⅛″ thick, a frame top 205 with width of 1¼″, a frame back 210 width of 1¼″, and a length of about 41 inches.

To bend the frame 200 to surround the light bar 40, an exemplary method is shown in FIG. 6, wherein notches 215 are cut in the top frame 205. Preferably the notches are 90 degrees wide, each side of the notch 215 having a 45 degree angle from the center of the notch 215.

FIG. 7 shows the frame 200 bent into its final shape with the sides of each notch 215 apposed. In this method, a wrench 220 holds the side 225 of the frame 200 in place, and a torch can be used to heat the frame for easier and permanent bending.

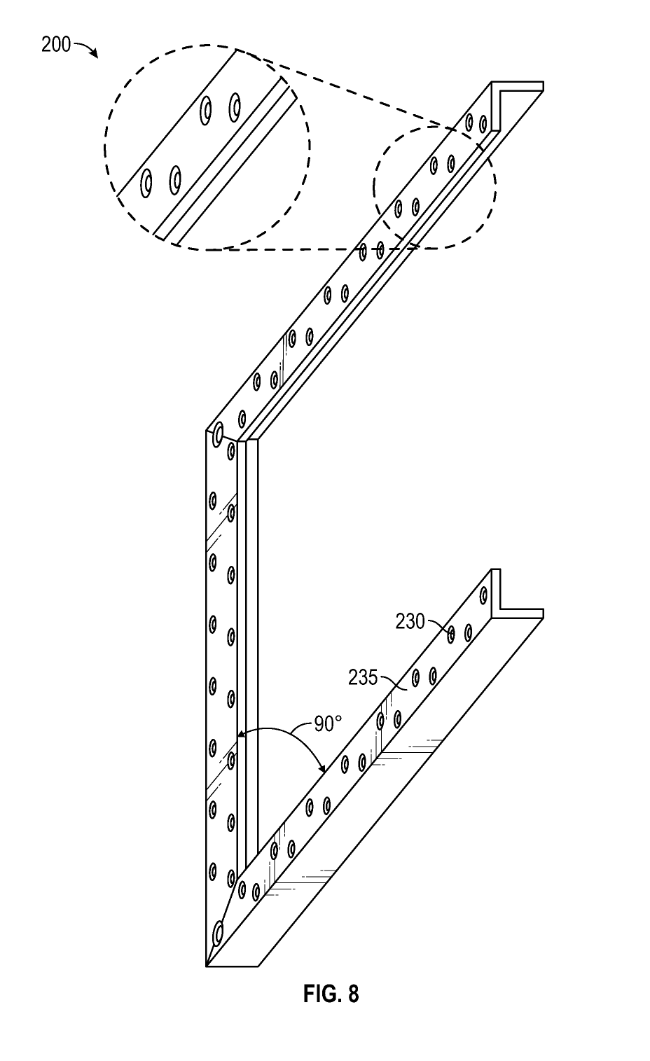

FIG. 8 shows two rows of holes 230 drilled into the frame top 205, permitting the hanging of two rows of decorations 80. There are a variety of ways to accommodate the hanging to two rows of decorations, and here are two. In one embodiment, the first row of holes 230 are drilled one inch apart and about one inch from the inner edge 235 of the frame 200 along the three sides of the frame 200. The second row of holes 230 are drilled one inch apart from each other about ⅛ inch from the edge of the frame top 205. The second row of holes 230 has the holes staggered between the first row of holes, to give the installed decorations 80 a richer, in-depth appearance (see later figures). At the upper left of FIG. 8, a blown up illustration of the holes 230 indicates a preferred structure illustrates a preferred configuration of the holes 230, with a larger diameter at the top (for easier installation) and narrower at the bottom of the hole 230 to retain the decorations 80 during frame movement as well as greater strength for the frame 200.

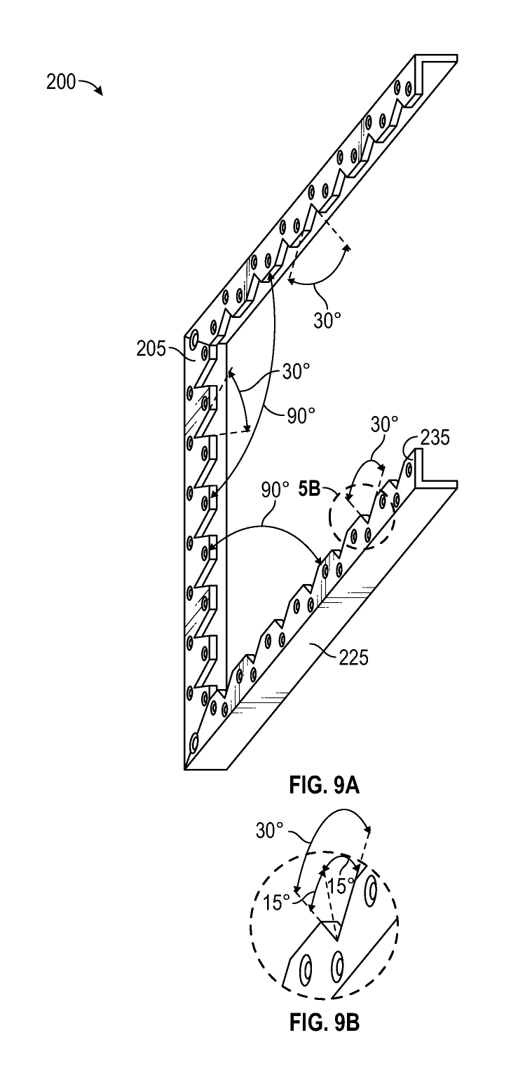

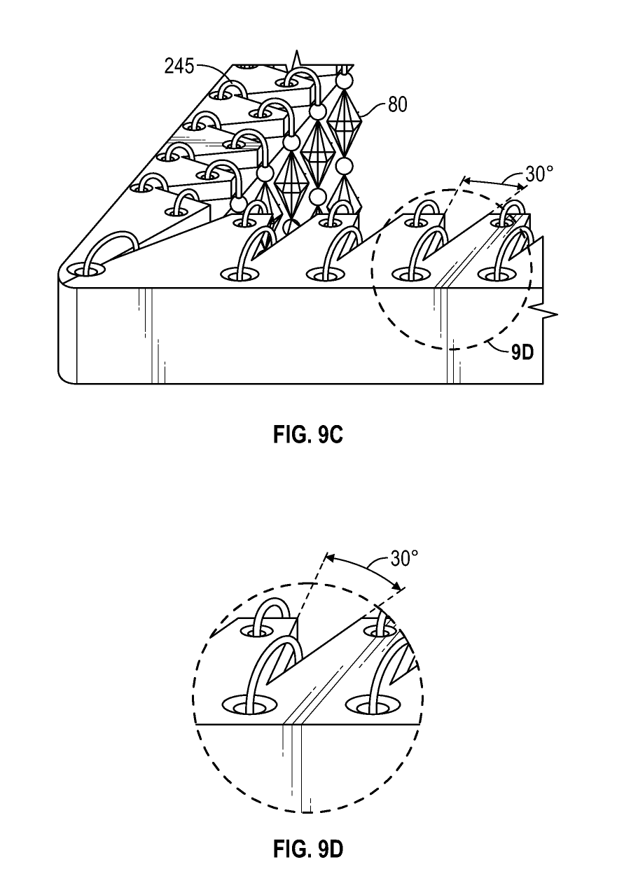

FIG. 9A shows another smaller notch 240 that accommodates the small convenient hook (not shown) on decorations 80. The small hooks may not be designed to encompass the 1-inch distance from the inner frame edge 235, hence we decided to place small notches 240 for ease of hanging. While the smaller notches 240 can have any side opening, a preferred notch is shown in FIG. 9B, at about 30 degrees. The notch need be no wider than the width of the hook (not shown), and can be much wider but not overlapping the holes 240 close to the inner frame edge 235. The smaller notches can be placed at various angles, including having one side perpendicular to the inner frame edge 235. FIG. 9D shows the hooks 245 in the holes 230 in the frame top 205. Note that the decorations 80 all hang along the inner frame edge 235. That way, as the decorations 80 hang down their hooks 245 are not visible outside the frame 200. The frame 200 is suspended higher than the light bar (not shown here), and the frame top 205 is not usually visible. FIG. 9D is an expanded version of the circle in FIG. 9C that is labeled 9D. It is a close up of the holes 230 and the relationship of the hooks 245 thereto. Another embodiment replaces the smaller notches 240 with troughs (not shown) between the inner and outer rows, in which the decorations 80 whose hooks 245 are in the farther hooks to dangle from the trough.

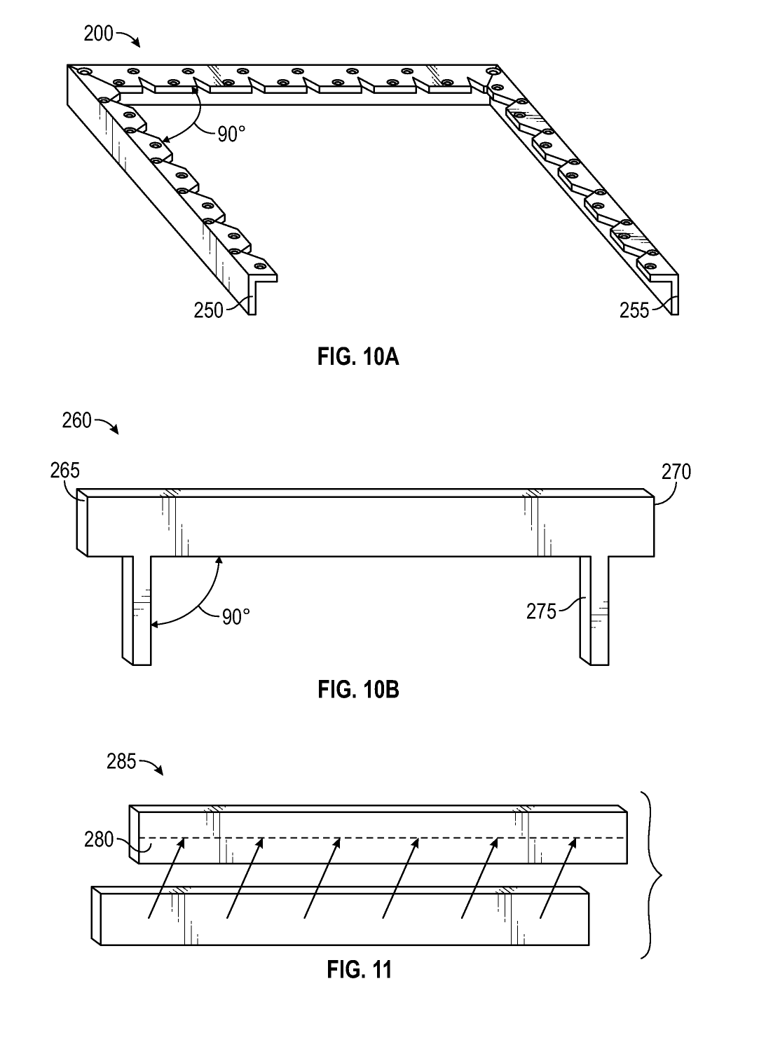

FIG. 10A shows the completed frame 200 with a first end of one side, frame end A 250, and a second end of the other side, frame end B 255. FIG. 10B shows an end piece 260, whose end piece A 265 is joined to frame end A 250 and whose end piece B 270 is joined to frame end B 255 to complete a rectangle shape. Note that this embodiment of end piece 260 also has two legs 275 that are used to install the completed accessory into a mounting bracket disclosed below. Optionally, legs 275 are attached directly to frame end A265 and frame end B 255.

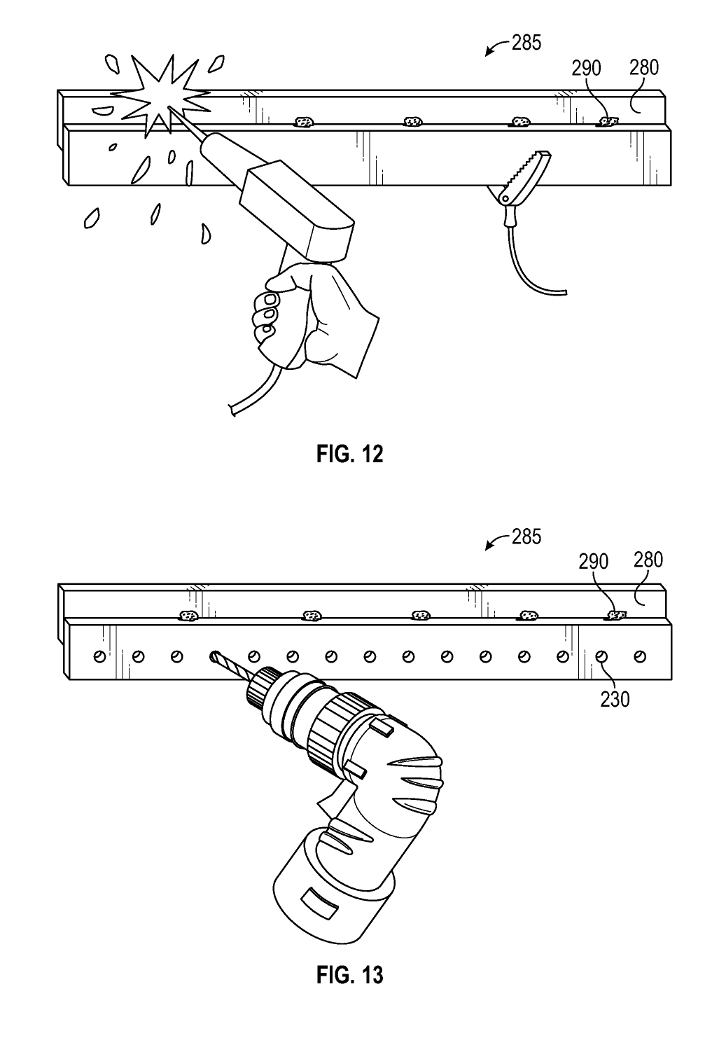

FIG. 11 illustrates the assembly of two bars 280 as a mounting bracket 285. The two bars 280 are usually less long than the center of the frame 280. The arrows indicate placement in a cantilevered shape, as indicated in FIG. 12. FIG. 12 shows the final placement of one bar 280 overlapping the other bar 280. In between the two bars are tack welds 290 that secure the positions of the bars. FIG. 13 shows an optional series of holes 230 in the lower bar, preferably in a perfect hole, as this needs to be aligned with the light bar 40. Preferably the holes 230 are drilled at about one inch intervals for convenient installation.

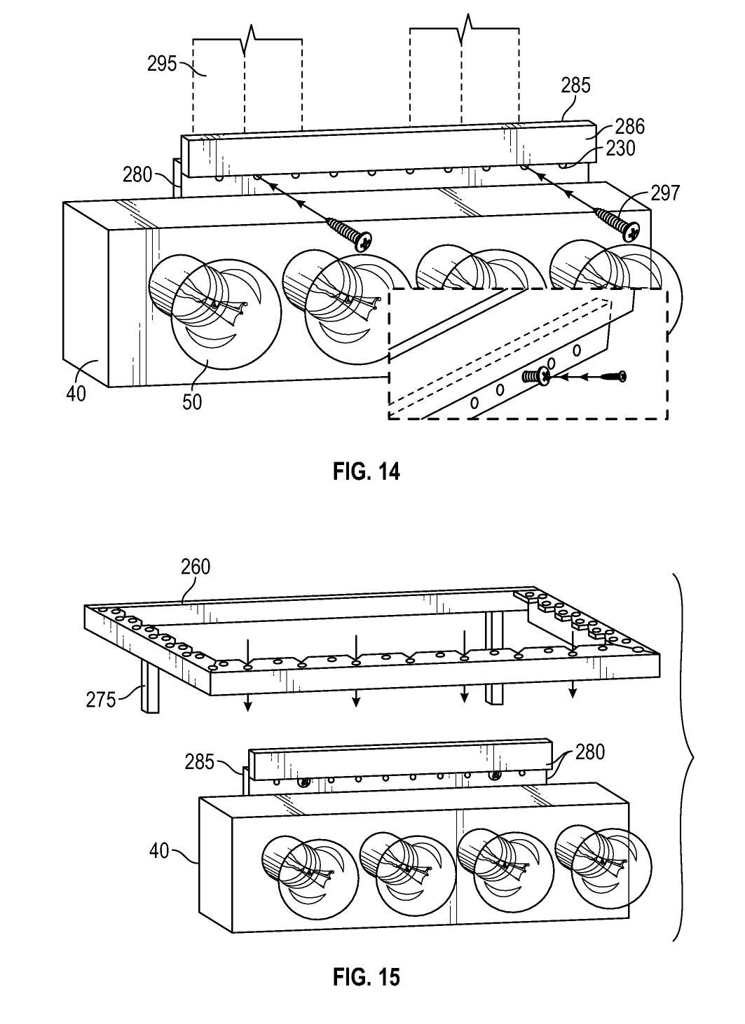

FIGS. 14 and 15 illustrate installation. FIG. 14 shows the mounting bracket 285 positioned in front of at least one stud 295, into which screws 297 are screwed through the predrilled holes 230 in mounting bracket 285. The lower bar 280 of the mounting bracket is thus flush against the wall behind the light bar 40. That leaves the upper bar 230 of the mounting bracket protruding above and slightly forward of the lower bar (positioned by the tack welds 290 discussed above).

FIG. 15 shows the new frame 200 positioned above the mounting bracket 285 and arrows indicate that the legs 275 of the accessory are inserted between the two bars 280 of the mounting bracket 285.

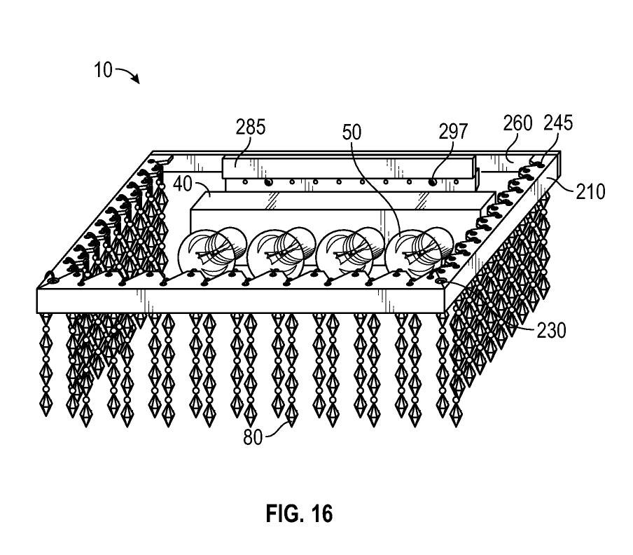

FIG. 16 shows an overview of the decorated light bar 40. The end piece 260 fits behind the upper bar 280 of the mounting bracket 285. Holes 230 and hooks 245 are not ordinarily visible. It can be seen that the new lighting accessory 10 positions decorations 80 around the light bulbs 50, thereby diffusing light and rendering a simple light bar 40 highly and individually decorative.

The present invention is described above with reference to a preferred embodiment. However, those skilled in the art will recognize that changes and modifications may be made in the described embodiment without departing from the nature and scope of the present invention. Various further changes and modifications to the embodiment herein chosen for purposes of illustration will readily occur to those skilled in the art. To the extent that such modifications and variations do not depart from the spirit of the invention, they are intended to be included within the scope thereof. For example, for ease of shipping, the ends may not be pre-bent but rather crimped for ease of installation. If preferred, crimping is not performed, but a crimping tool is added to the light bar accessory kit for individual crimping to exactly fit the home light bar. Preferably the light bar accessory is provided as described above and then packaged for easy installation. The light bar accessory kit can include the accessory and one or more sets of hanging ornaments. For example, for holiday sales, appropriate holiday colors can be used on the ornaments. Alternately, ornaments shaped like holiday symbols can be used. Examples of these include but are not limited to hearts, Christmas trees, turkeys, ghosts and flags.

The light bar accessory can be constructed from aluminum or a variety of others materials, including but not limited to steel, plastic and composites. Where possible, the circular bars can be hollow to provide similar strength with less weight. The materials may be welded, glued, screwed or bolted together. The light bar accessory can be constructed from molded metal or other materials.

Reference throughout this specification to an “embodiment,” an “example” or similar language means that a particular feature, structure, characteristic, or combinations thereof described in connection with the embodiment is included in at least one embodiment of the present invention. Thus appearances of the phrases an “embodiment,” and “example,” and similar language throughout this specification may, but do not necessarily, all refer to the same embodiment, to different embodiments, or to one or more of the figures. Additional, reference to the words “embodiment,” “example” or the like for two or more features, elements, etc., does not mean that the features are necessarily related, dissimilar, the same, etc.

Each statement of an embodiment or example is to be considered independent of any other statement of an embodiment despite any use of similar or identical language characterizing each embodiment. Therefore, where on embodiment is identified as “another embodiment,” the identified embodiment is independent of any other embodiments characterized by the language “another embodiment.” The features, functions and the like described herein are considered to be able to be combined in whole or in part one with another as the claims and/or art may direct, either directly or indirectly, implicitly or explicitly.

As used herein, “comprising,” “including,” “containing,” “is,” “are,” “characterized by,” and grammatical equivalents thereof are inclusive or open-ended terms that do not exclude additional un-recited elements or method steps. “Comprising” is to be interpreted broadly and including the more restrictive terms “consisting of” and “consisting essentially of.”

Reference throughout this specification to features, advantages, or similar language does not imply that all of features and advantages that may be realized with the present invention should be or are in any single embodiment of the invention. Rather, language referring to the features and advantages is understood to mean that a specific feature, advantage or characteristic described in connection with an embodiment is included in at least one embodiment of the present invention. Thus, discussion of the features and advantages, and similar language, throughout this specification may, but does not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

1. A decorative light bar accessory, comprising a three-sided frame having two frame sides and a frame middle segment, each of the frame sides and the frame middle segment comprising a frame top and a frame back, the frame sides being attached to the frame middle segment at approximately right angles and having a free frame end, each frame top having a plurality of spaced apart holes, the holes sized to accommodate hooks for decorations that are suspended therefrom, the free frame ends being adapted to suspend the decorative light bar accessory over a light bar.

2. The decorative light bar accessory of claim 1 further comprising an end piece whose two ends are attached to the two free frame ends.

3. The decorative light bar accessory of claim 2, wherein the end piece has two interfaces that fit into a mounting bracket, thereby suspending the decorative light bar accessory over a light bar.

4. The decorative light bar accessory of claim 3, wherein the two interfaces on the end piece are vertical legs that can be inserted into a mounting bracket.

5. The decorative light bar accessory of claim 1, further comprising an end piece whose two ends are attached to the free frame ends, the end piece further comprising a plurality of legs that can be inserted into a mounting bracket comprising two bars attached to each other longitudinally and in parallel and cantilevered to provide an overlap of about 50%, the two bars being attached in a spaced apart fashion, leaving room for insertion of the legs, with one bar designed to interface in the vicinity of the light bar with screw holes to insert screws for attachment to a wall.

6. An aesthetic accessory to an existing light bar, comprising
a) at least two mounting clamps, each comprising a short narrow section of metal with folded ends, with the section being sized to encircle the compression ring of a light bulb of an existing light bar, each folded end having at least one hole through which a bolt is passed and onto which a fastening nut is screwed;
b) at least two frame supports, each of which has two ends, one end attached to one of the at least two mounting clamps and a second end attached to a frame bar;
c) at least one frame bar that is attached to at least two frame supports, the frame bar extending at least the width of a light bar and having two ends that are bent to cover the light bar, the frame bar having holes at intervals; and
d) a plurality of decorations that are suspended from the holes in the frame bar.

7. The aesthetic accessory of claim 6 wherein the frames are fabricated to various lengths, which attach to standard consumer light bar fixtures.

8. The aesthetic accessory of claim 6 wherein the frame is affixed to either the existing fixture or the wall.

9. The aesthetic accessory of claim 6 wherein the frame is affixed to the wall via a typical consumer mounting system.

10. The aesthetic accessory of claim 6 wherein the frame is affixed to the light fixture via a clamping system.

11. The aesthetic accessory of claim 7 wherein an aesthetic light valance is added to the frame through either an after-assembly attachment by the consumer or by permanent attachment at the time of manufacture.

12. The aesthetic accessory of claim 6, wherein onto the fixture is a wall mounting system that comprises a short narrow section of metal with folded ends, with the section being sized to encircle the base of an existing light bar.

13. The methods of claim 6, wherein the accessory is a decorative bar, which contains holes and/or other means of attaching decorative objects, thereby providing a new aesthetic appearance, thereby better reflecting and distributing light from the light bar fixture.

14. A light bar accessory kit comprising
a) packaging including instructions for assembly and use as directed;
b) a light bar accessory; and
c) decorative elements to be disposed on the accessory.

15. The light bar accessory kit of claim 14 wherein the decorative elements comprise
i) decorative crystals and glass materials;
ii) seasonal decorations (e.g. Halloween);
iii) sports themes (e.g. teams and team); and/or
iv) miscellaneous themes (e.g. personalization).

16. A method for adding an aesthetic accessory to an existing light bar.
a) providing a light bar accessory, comprising
i) at least two mounting clamps, each comprising a short narrow section of metal with folded ends, with the section being sized to encircle the compression ring of a light bulb of an existing light bar, each folded end having at least one hole through which a bolt is passed and onto which a fastening nut is screwed;
ii) at least two frame supports, each of which has two ends, one end attached to one of the mounting clamps and a second end attached to a frame bar;
iii) at least one frame bar that is attached to at least two frame supports, the frame bar extending at least the width of a light bar and having two ends that are bent to cover the light bar, the frame bar having holes at intervals;
iv) A plurality of decorations that are suspended from the holes in the frame bar; and
v) a light bar frame fastening system to attach the frame to either the light fixture or the wall behind the fixture;
b) turning a light switch to off position;
c) removing two outer light bulbs from the light fixture;
d) slipping the light bar accessory over two bare light bulb compression ring fittings; and
e) replacing the light bulbs.
